(19) United States
(12) Patent Application Publication
(10) Pub. No.: US 2011/0069660 A1
(43) Pub. Date: Mar. 24, 2011

(54) FEMTOCELL AND RESOURCE ALLOCATION METHOD THEREOF

(75) Inventors: Hsuan-Li LIN, Taipei City (TW); Yu-Shen CHOU, Taipei City (TW); Ching-Yao HUANG, Hsinchu City (TW); Sheng-Lun CHIOU, Changhua County (TW)

(73) Assignee: INSTITUTE FOR INFORMATION INDUSTRY, Taipei (TW)

(21) Appl. No.: 12/884,427

(22) Filed: Sep. 17, 2010

Related U.S. Application Data
(60) Provisional application No. 61/243,551, filed on Sep. 18, 2009.

(51) Int. Cl. H04W 28/08; H04J 4/00

(52) U.S. Cl. 370/328; 370/330

(57) ABSTRACT

A femtocell and a resource allocation method thereof are provided. The femtocell comprises a storage unit and a processing unit. The storage unit is configured to store a priority region threshold. The processing unit is configured to assign a first region of a frame as a CSG region according to a priority region threshold and assign a second region of the frame as a non-CSG region according to the priority region threshold. The CSG region and the non-CSG region are exclusive.

### PRIORITY

This application claims the benefit of U.S. Provisional Application Ser. No. 61/243,551 filed on Sep. 18, 2009, which is hereby incorporated by reference herein.

### FIELD

The present invention relates to a femtocell and a resource allocation method thereof; more particularly, the present invention relates to a femtocell and a resource allocation method thereof that can solve the problems of dead zones.

### BACKGROUND

A femtocell is a cellular access point that can be deployed in a network system to extend coverage (especially indoor coverage) of a mobile operator and reduce the cost of deploying a macrocell. A femtocell is sometimes referred to as a home base station, a small cellular base station, or a Home (e)NodeB in the 3^{rd} Generation Partnership Project (3GPP).

FIG. 1A depicts a conventional network system 1 that adopts a femtocell 11. At the back end, the femtocell 11 is connected to the network (including a gateway 15 and a core network 13) of the mobile operator by an existing wired network technology (e.g., through a Digital Subscriber Line (DSL) modem or through a cable modem). At the front end, the femtocell uses a licensed wireless frequency band, so no change need to be made on user equipments 12, 14, 16 subscribing the network. The user equipments 12, 14, 16 use the best link quality with their neighboring femtocell, such as the femtocell 11.

From the viewpoint of femtocells, there are two kinds of members (i.e. user equipments that subscribe the network): Closed Subscriber Group (CSG) member and non-CSG member. A CSG member is granted to access the femtocell, while a non-CSG member is treated as a foreigner and may not access the femtocell. Access modes provided by femtocells can be categorized into three types: closed access mode, open access mode, and hybrid access mode. A femtocell that is in a closed access mode means that only a CSG member can access the femtocell. A femtocell that is in an open access mode means that both a CSG member and a non-CSG member can access the femtocell, and they are treated equally. Finally, a femtocell that is in a hybrid access mode means that a CSG member has a higher priority than a non-CSG does.

For a femtocell that is in a hybrid access mode, both uplink and downlink transmissions introduce dead zones. FIG. 1B illustrates an uplink transmission scenario that causes a dead zone 102 to CSG members, such as the user equipment 14. In FIG. 1B, the femtocell 11 is in a hybrid access mode, the user equipment 14 is a CSG member, and the user equipment 12 is a non-CSG member. When the femtocell 11 runs out of service, it blocks the non-CSG members, such as the user equipment 12. The user equipment 12 then establishes a link with the macrocell 17. The user equipment 12 has to boost its power to increase the probability of successful uplink transmission with the macrocell 17. Nevertheless, the transmissions between the user equipment 14 and the femtocell 11 will be interfered by the user equipment 12 and have poor qualities. The area that is interfered by the user equipment 12 and has poor transmission quality is called a dead zone 102.

FIG. 1C illustrates a downlink transmission scenario that causes a dead zone 104 to non-CSG members, such as the user equipment 12. Likewise, the femtocell 11 is in a hybrid access mode, the user equipment 14 is a CSG member, and the user equipment 12 is a non-CSG member. The user equipment 12 is blocked by the femtocell 11 and then connected to the macrocell 17. Since the user equipment 12 is closer to the femtocell 11 than to the macrocell 17, the downlink transmissions between the user equipment 12 and the macrocell 17 are interfered by the femtocell 11 and have poor qualities. The area that is interfered by the femtocell 11 and has poor transmission quality is called a dead zone 104.

According to the above descriptions, there is a need to solve the problems of dead zones of the current femtocells.

### SUMMARY

An objective of certain embodiments of the present invention is to provide a resource allocation method for use in a femtocell. The resource allocation method comprises the steps of: (a) enabling the femtocell to assign a first region of a frame as a Closed Subscriber Group (CSG) region according to a priority region threshold, and (b) enabling the femtocell to assign a second region of the frame as a non-CSG region according to the priority region threshold. It is noted that the CSG region and the non-CSG region are exclusive.

Another objective of certain embodiments of the present invention is to provide a femtocell. The femtocell comprises a storage unit and a processing unit. The storage unit is configured to store a priority region threshold. The processing unit is configured to assign a first region of a frame as a CSG region according to a priority region threshold and assign a second region of the frame as a non-CSG region according to the priority region threshold. It is noted that the CSG region and the non-CSG region are exclusive.

The femtocell and the resource allocation method thereof of certain embodiments of the present invention utilize a priority region threshold to divide a frame into a CSG region and a non-CSG region. Regarding the non-CSG region, a user equipment that is a non-CSG member to the femtocell has a higher priority to use resources within the non-CSG region than a user equipment that is a CSG member does. If there is an available resource in the non-CSG region, a user equipment that is a CSG member is able to use it. Regarding the CSG region, a user equipment that is a CSG member to the femtocell has a higher priority to use resources within the CSG region than a user equipment that is a non-CSG member does. By doing so, the problems of dead zones can be eased.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A illustrates a conventional network system that adopts a femtocell;

FIG. 1B illustrates an uplink transmission scenario that causes a dead zone to CSG members;

FIG. 1C illustrates a downlink transmission scenario that causes a dead zone to non-CSG members;

FIGS. 2A, 2B, and 2C illustrate a first embodiment of the present invention;

FIGS. 2D, 2E, 2F, 2G, 2H, and 2I individually illustrate a frame being assigned a CSG-region and a non-CSG region;

FIG. 2J illustrates a frame conforming to the Long Term Evolution (LTE) standard; and

FIG. 3 illustrates a flowchart of a second embodiment of the present invention.

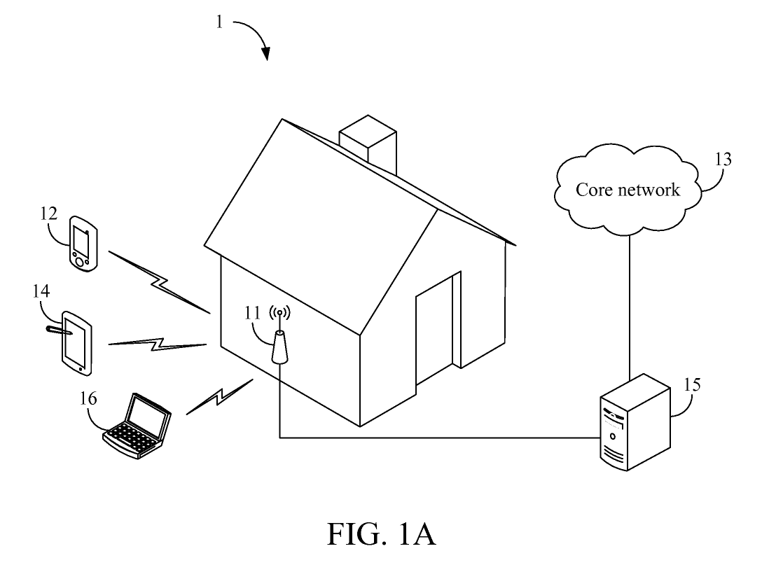

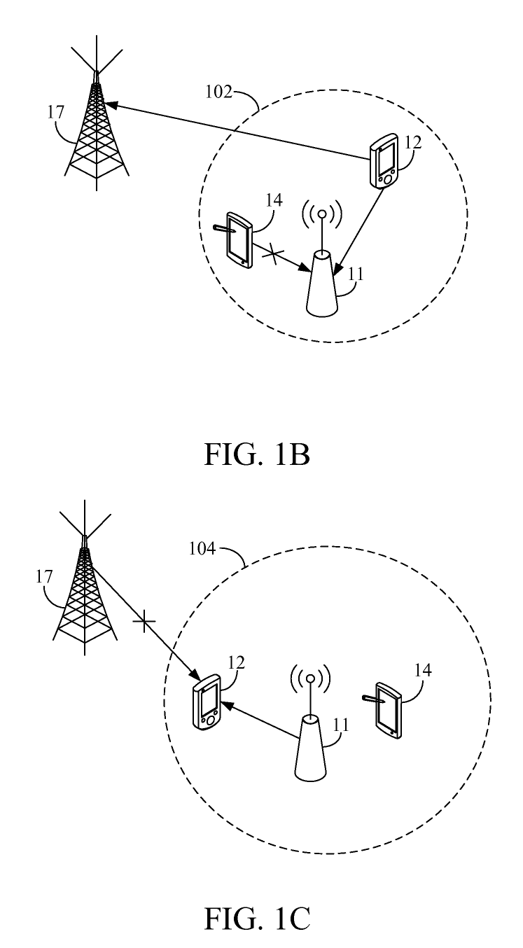

### DETAILED DESCRIPTION

In the following descriptions, the present invention will be explained with reference to various example embodiments; nevertheless, these embodiments are not intended to limit the present invention to any specific example, environment, embodiment, applications, or particular implementations described in these example embodiments. Therefore, descriptions of these example embodiments are only provided for purpose of illustration but not to limit the present invention. It should be appreciated that elements unrelated directly to the present invention are omitted from the embodiments and the attached drawings.

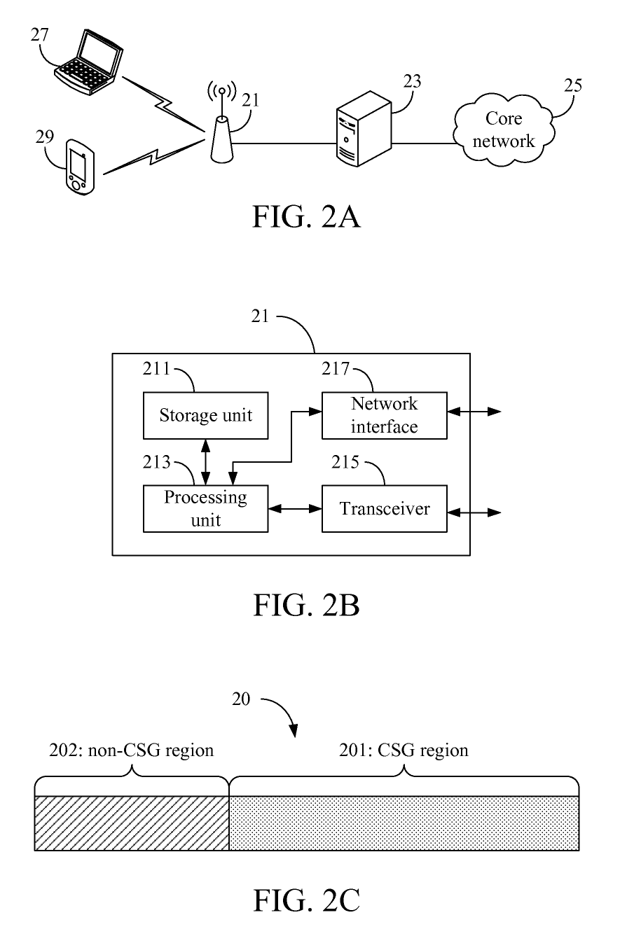

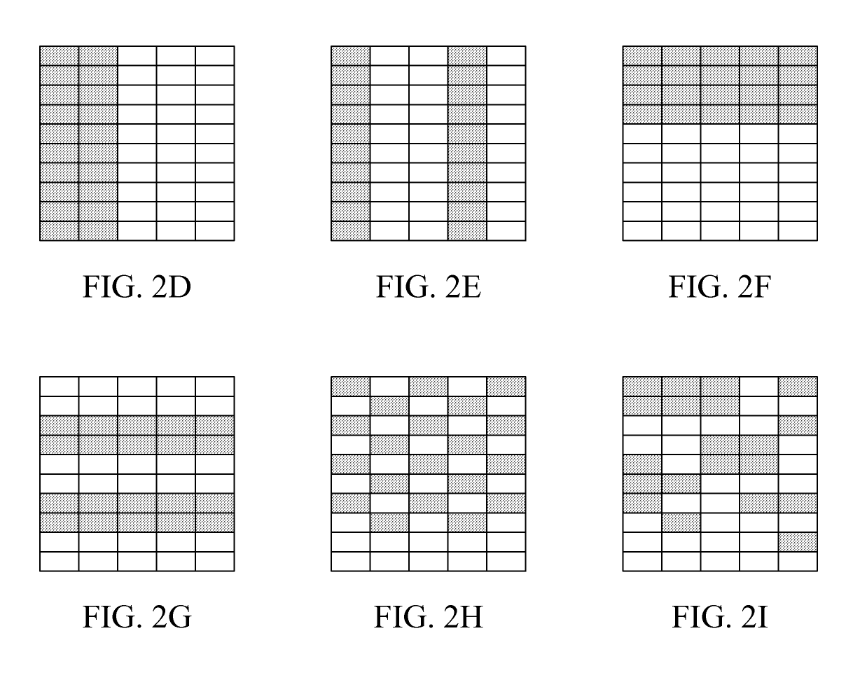

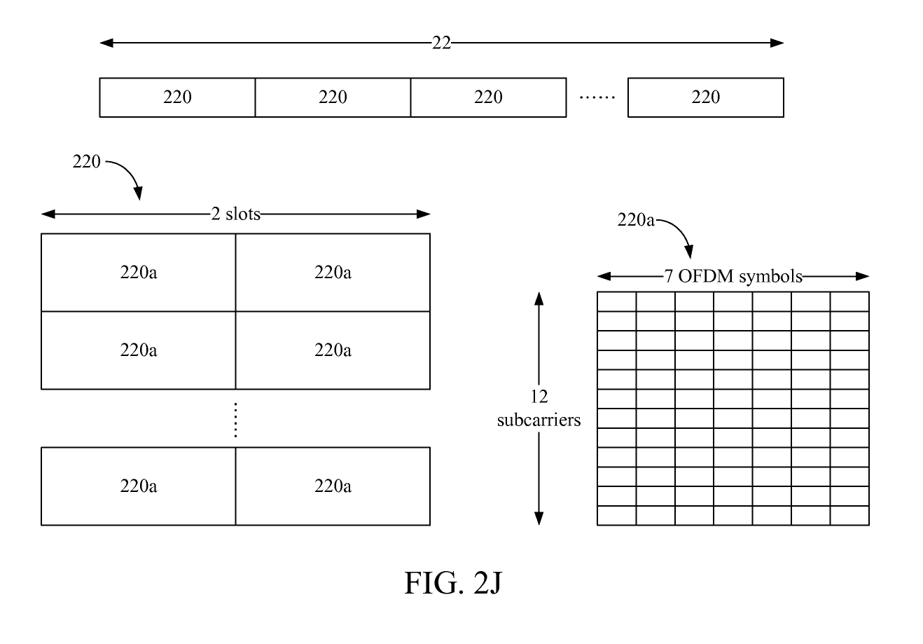

FIGS. 2A and 2B illustrate a first example embodiment of the present invention. A femtocell 21 is connected to a core network 25 through a gateway 23 using wired network technology. Two user equipments 27, 29 are wirelessly connected to the femtocell 21. The user equipment 27 is a CSG member to the femtocell 21, while the user equipment 29 is a non-CSG member to the femtocell 21. The femtocell 21 comprises a storage unit 211, a processing unit 213, a transceiver 215, and a network interface 217. The femtocell 21 is connected to the gateway 23 via its network interface 217. The user equipments 27, 29 are individually connected to the transceiver 215 of the femtocell 21.

The storage unit 211 is configured to store a priority region threshold. When the processing unit 213 has to process a frame 20, the processing unit 211 assigns a first region of a frame as a CSG region 201 according to the priority region threshold and assigns a second region of the frame as a non-CSG region 202 according to the priority region threshold. It is noted that the CSG region 201 and the non-CSG region 202 are exclusive. Regarding the CSG region 201, CSG members have higher priority to use resources in this region than non-CSG members do. When there are an available resource in the CSG region 201, non-CSG members can use them. Regarding the non-CSG region 202, non-CSG members have higher priority to use resources in this region than the CSG members do. When there is an available resource in the non-CSG region 202, CSG members could use them.

The processing unit 213 may assign the CSG-region and the non-CSG region of a frame according to the priority region threshold through various ways as shown in FIGS. 2D, 2E, 2F, 2G, 2H, and 2I. FIGS. 2D, 2E, 2F, 2G, 2H, and 2I individually illustrate a frame, wherein the horizontal axes represent frequency, the vertical axes represent time, and each small rectangle represents a scheduling unit. Specifically, each of the scheduling units represents a smallest unit of the resources that can be assigned to a user equipment. In FIGS. 2D, 2E, 2F, 2G, 2H, and 2I, scheduling units in grey color belong to non-CSG region, scheduling units in white color belong to CSG region, and the priority region threshold is set in a way that 40% of the scheduling units of a frame belong to the non-CSG region and 60% of the scheduling units of a frame belong to the CSG region. In FIGS. 2D and 2E, the CSG-region and the non-CSG region are assigned on a frequency division basis. In FIGS. 2F and 2G, the CSG-region and the non-CSG region are assigned on a time division basis. In FIG. 2H, the CSG-region and the non-CSG region are assigned according to a pattern. In FIG. 2I, the CSG-region and the non-CSG region are assigned randomly.

To elaborate the idea of a scheduling unit, an example of a frame 22 conforming to the Long Term Evolution (LTE) standard is given in FIG. 2J. The frame 22 comprises ten subframes 220. Each of the subframes 220 is divided into two slots in the horizontal axis and is divided into a plurality of resource blocks in the vertical axis. A duration of a slot is 0.5 ms. After the division, each of the subframes 220 comprises a plurality of physical resource blocks 220a. In the LTE standard, a physical resource block 220a comprises six or seven Orthogonal Frequency-Division Multiplexing (OFDM) symbols in the horizontal axis and twelve subcarriers in the vertical axis. Given the above LTE frame 22, a scheduling unit may comprises only one single physical resource block, two consecutive physical resource blocks in the horizontal direction, etc. It is noted that the present invention does not limit the number of physical resource blocks comprised in a scheduling unit. In addition, the present invention is not limited to the LTE standard.

To achieve better performance, the priority region threshold may be decided according to the location of the femtocell 21 and/or the density of user equipments in the coverage of the femtocell 21. For example, two parameters may be used to evaluate the goodness of the priority region threshold: the effective data rate when using only one or more macrocells (denoted as Eff_data_rate_{macro}_{_{—}}_{only}) and the effective data rate when adopting the femtocell 21 (denoted as Eff_data_rate_{with}_{_{—}}_{femtocell}). If the priority region threshold can make Eff_data_rate_{with}_{_{—}}_{femtocell} being greater than Eff_data_rate_{macro}_{_{—}}_{only}, the priority region threshold is a good one. Therefore, one may use the following equation to derive the priority region threshold:

Eff_data_rate_{macro}_{_{—}}_{only}<Eff_data_rate_{with}_{_{—}}_{femtocell} (1)

The equation (1) is equivalent to the following equation:

$$\frac{{r}_{{M}_{0} , x} ( {γ}_{{M}_{0} , x} )}{\vert {μ}_{{M}_{0}} \vert} < \frac{{α}_{k , x} \cdot {r}_{k , x} ( {γ}_{k , x} )}{\vert {μ}_{k} \vert} \qquad ( 2 )$$

wherein the parameter M₀ represents the macrocell, the parameter x represents the user equipment (e.g. the user equipments 27, 29), and the parameter k denotes the femtocell (e.g. the femtocell 21). The parameter r represents the system capacity. The parameter γ is calculated by the reference signal received power (RSRP) function, which is familiar to people skilled in the art. In addition, the parameter μ represents the average number of the user equipments, the parameter α_{k,x} represents the resource amount that the user equipment required from the femtocell, and the parameter αₖ represents the priority region threshold. For better performance,

$${α}_{k} = {max}_{\vert {μ}_{k} \vert} {α}_{k , x} .$$

The following descriptions will focus on the usages of the CSG region 201 and the non-CSG region 202. It is assumed that the user equipment 27 just handovers to the femtocell 21. The processing unit 213 acquires a user type of the user equipment 27. The processing unit 213 determines that the user type of the user equipment 27 is CSG. Afterwards, the processing unit 213 allocates at least one scheduling unit in the CSG region 201 of the frame 20 to the user equipment 27. It is noted that the number of scheduling units in the CSG region 201 assigned to the user equipment 27 is adjustable and is not used to limit the scope of the present invention. In this embodiment, the processing unit 213 may further determines that if at least one scheduling unit is available in the non-CSG region 202. If there is at least one available scheduling unit in the non-CSG region 202, the processing unit 213 will allocates at least one available scheduling unit in the non-CSG region 202 to the user equipment 27. Similarly, the number of scheduling units in the non-CSG region 202 assigned to the user equipment 27 is adjustable and is not used to limit the scope of the present invention.

It is assumed that the user equipment 29 just handovers to the femtocell 21. The processing unit 213 acquires a user type of the user equipment 29. The processing unit 213 determines that the user type of the user equipment 29 is non-CSG. Afterwards, the processing unit 213 allocates at least one scheduling unit in the non-CSG region 202 of the frame 20 to the user equipment 29. It is noted that the number of scheduling units in the non-CSG region 202 assigned to the user equipment 29 is adjustable and is not used to limit the scope of the present invention. In this embodiment, the processing unit 213 may further determines that if at least one scheduling unit is available in the CSG region 201. If there is at least one available scheduling unit in the CSG region 201, the processing unit 213 will allocates at least one available scheduling unit in the CSG region 201 to the user equipment 29. Similarly, the number of scheduling units in the CSG region 201 assigned to the user equipment 29 is adjustable and is not used to limit the scope of the present invention.

According to the above descriptions, it is learned that the femtocell 21 assigns a CSG region and a non-CSG region in a frame according to a priority region threshold. Thereafter, CSG members (e.g. the user equipment 27) have higher priorities to use the CSG region 201 and non-CSG members (e.g. the user equipment 29) have higher priorities to use the non-CSG region 202. It is noted that when frames are classified into uplink frames and downlink frames, two priority region thresholds can be used, wherein one priority region threshold is for uplink frames and the other priority region threshold is for downlink frames.

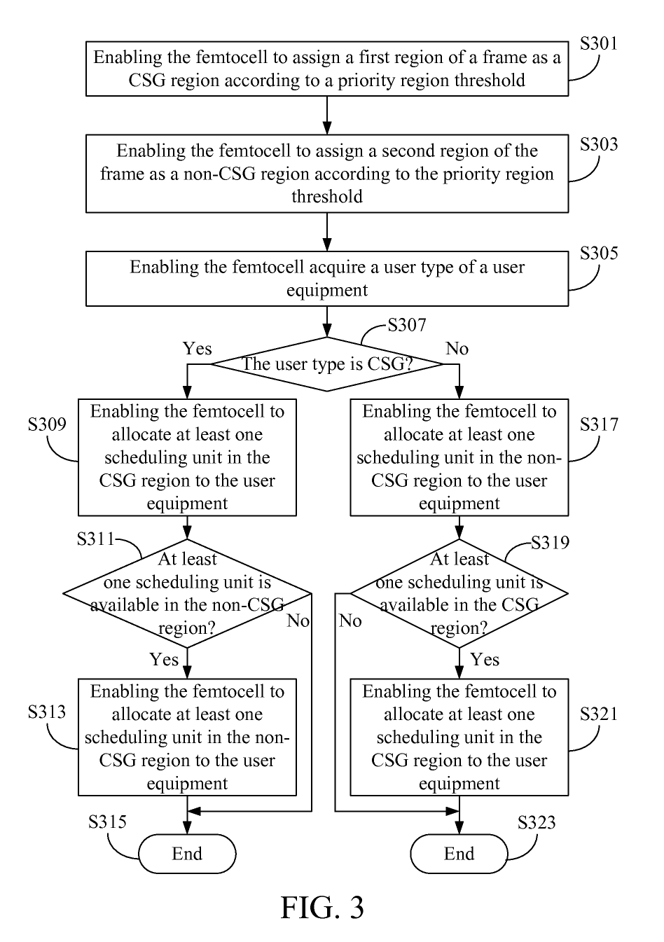

A second embodiment of the present invention is a resource allocation method, whose flowchart is drawn in FIG. 3. The resource allocation method can be used in a femtocell, such as the femtocell 21 in the first embodiment.

First, the resource allocation method executes step S301 to enable the femtocell to assign a first region of a frame as a CSG region according to a priority region threshold. Then, step S303 is executed to enable the femtocell to assign a second region of the frame as a non-CSG region according to the priority region threshold. It is noted that the step S303 may be executed before the step S301. The resource allocation method then executes step S305 to enable the femtocell to acquire a user type of a user equipment. In step S307, the resource allocation method enables the femtocell to determine whether the user type is CSG. If the user type is CSG, then steps S309 to S315 are executed. If the user type is not CSG, it means that the user type is non-CSG and then steps 317 to 321 are executed.

When the user type is CSG, step S309 is executed to enable the femtocell to allocate at least one scheduling unit in the CSG region to the user equipment. Afterwards, step 311 is executed to enable the femtocell to determine whether at least one scheduling unit is available in the non-CSG region. If it is yes in step S311, then the step S313 is executed to enable the femtocell to allocate at least one scheduling unit of the non-CSG region to the user equipment. Next, step S315 is executed to finish the resource allocation method. If it is no in step S311, the resource allocation method proceeds to the step S315 directly.

When the user type is non-CSG, step S317 is executed to enable the femtocell to allocate at least one scheduling unit in the non-CSG region to the user equipment. Afterwards, step 319 is executed to enable the femtocell to determine whether at least one scheduling unit is available in the CSG region. If it is yes in step S319, then the step S321 is executed to enable the femtocell to allocate the scheduling unit of the CSG region to the user equipment. Next, step S323 is executed to finish the resource allocation method. If it is no in step S319, the resource allocation method proceeds to the step S323 directly.

In addition to the aforesaid steps, the second embodiment can also execute all the operations set forth in the first embodiment. How the second embodiment executes these operations will be readily appreciated by those of ordinary skill in the art based on the explanation of the first embodiment, and thus will not be further described herein.

The femtocell and the resource allocation method thereof of the present invention utilize a priority region threshold to divide a frame into a CSG region and a non-CSG region. Regarding the non-CSG region, a user equipment that is a non-CSG member to the femtocell has a higher priority to use the resource within the non-CSG region than a user equipment that is a CSG member does. If there is available resource in the non-CSG region, a user equipment that is a CSG member is able to use it. Regarding the CSG region, a user equipment that is a CSG member to the femtocell has a higher priority to use the resource within the CSG region than a user equipment that is a non-CSG member does. By doing so, the problems of dead zones can be eased.

Since a frame comprises both a CSG region and a non-CSG region, both CSG members and non-CSG members can be served by the femtocell. The problems of dead zones caused by macrocells can be avoided. In addition, in the condition that all the CSG members have been served and the CSG region still has available scheduling units (i.e. resources), non-CSG member can use them. Likewise, in the condition that all the non-CSG members have been served and the non-CSG region still has available scheduling units (i.e. resources), CSG member can use them. Therefore, the data rate of the user equipments served by the femtocell can be increased as well.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A resource allocation method for use in a femtocell, comprising the steps of:
(a) enabling the femtocell to assign a first region of a frame as a Closed Subscriber Group (CSG) region according to a priority region threshold; and
(b) enabling the femtocell to assign a second region of the frame as a non-CSG region according to the priority region threshold;
wherein the CSG region and the non-CSG region are exclusive.

2. The resource allocation method of claim 1, wherein the step (a) assigns the CSG region of the frame on a frequency division basis and the step (b) assigns the non-CSG region of the frame on the frequency division basis.

3. The resource allocation method of claim 1, wherein the step (a) assigns the CSG region of the frame on a time division basis and the step (b) assigns the non-CSG region of the frame on the time division basis.

4. The resource allocation method of claim 1, wherein the frame is one of an uplink frame and a downlink frame.

5. The resource allocation method of claim 1, further comprising the following steps of:
(c) enabling the femtocell to acquire a user type of a user equipment;
(d) enabling the femtocell to determine that the user type is CSG; and
(e) enabling the femtocell to allocate a scheduling unit in the CSG region to the user equipment.

6. The resource allocation method of claim 5, further comprising the following steps of:
(f) enabling the femtocell to determine that a scheduling unit is available in the non-CSG region; and
(g) enabling the femtocell to allocate the scheduling unit of the non-CSG region to the user equipment.

7. The resource allocation method of claim 6, wherein the scheduling unit of the CSG region comprises a physical resource block of the CSG region and the scheduling unit of the non-CSG region comprises a physical resource block of the non-CSG region.

8. The resource allocation method of claim 1, further comprising the following steps of:
(c) enabling the femtocell to acquire a user type of a user equipment;
(d) enabling the femtocell to determine that the user type is non-CSG; and
(e) enabling the femtocell to allocate a scheduling unit in the non-CSG region to the user equipment.

9. The resource allocation method of claim 8, further comprising the following steps of:
(f) enabling the femtocell to determine that a scheduling unit is available in the CSG region; and
(g) enabling the femtocell to allocate the scheduling unit of the CSG region to the user equipment.

10. The resource allocation method of claim 9, wherein the scheduling unit of the CSG region comprises a physical resource block of the CSG region and the scheduling unit of the non-CSG region comprises a physical resource block of the non-CSG region.

11. A femtocell, comprising:
a storage unit, being configured to store a priority region threshold; and
a processing unit being configured to assign a first region of a frame as a CSG region according to a priority region threshold and assign a second region of the frame as a non-CSG region according to the priority region threshold;
wherein the CSG region and the non-CSG region are exclusive.

12. The femtocell of claim 11, wherein the processing unit assigns the CSG region and the non-CSG region of the frame on a frequency division basis.

13. The femtocell of claim 11, wherein the processing unit assigns the CSG region and the non-CSG region of the frame on a time division basis.

14. The femtocell of claim 11, wherein the frame is one of an uplink frame and a downlink frame.

15. The femtocell of claim 11, wherein the processing unit further acquires a user type of a user equipment, determines that the user type is CSG, and allocates a scheduling unit in the CSG region to the user equipment.

16. The femtocell of claim 15, wherein the processing unit further determines that a scheduling unit is available in the non-CSG region and allocates the scheduling unit of the non-CSG region to the user equipment.

17. The femtocell of claim 16, wherein the scheduling unit of the CSG region comprises a physical resource block of the CSG region and the scheduling unit of the non-CSG region comprises a physical resource block of the non-CSG region.

18. The femtocell of claim 11, wherein the processing unit further acquires a user type of a user equipment, determines that the user type is non-CSG, and allocates a scheduling unit in the non-CSG region to the user equipment.

19. The femtocell of claim 18, wherein the processing unit further determines that a scheduling unit is available in the CSG region and allocates the scheduling unit of the CSG region to the user equipment.

20. The femtocell of claim 19, wherein the scheduling unit of the CSG region comprises a physical resource block of the CSG region and the scheduling unit of the non-CSG region comprises a physical resource block of the non-CSG region.
